(19) United States
(12) Patent Application Publication
(10) Pub. No.: US 2006/0185395 A1
(43) Pub. Date: Aug. 24, 2006

(54) Method of manufacturing curved glass using microwaves

(76) Inventors: Vladislav Sklyarevich, Bensalem, PA (US); Mykhaylo Shevelev, Feasterville, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/354,689

(22) Filed: Feb. 15, 2006

Related U.S. Application Data
(60) Provisional application No. 60/653,398, filed on Feb. 15, 2005.

(51) Int. Cl. C03B 23/02; C03B 32/00

(52) U.S. Cl. 65/60.5; 65/106

(57) ABSTRACT

A method for making curved glass sheets (6) with an applied opaque layer (7) (e.g., enamel or water-based) wherein the sheet is passed through a tunnel furnace (1) having a number of gas or infrared (2) and microwave beam (3,4) heating sections. At least two microwave beam heating sections (3,4) are installed in the furnace and in each of them, a microwave beam (5) with appropriate frequency and power density, is provided to accomplish firing or curing (3) of the opaque layer (7) and shaping (4) of the profile.

### CROSS REFERENCE

This application is based upon Provisional Application No. U.S. 60/653,398, filed on Feb. 15, 2005.

### FIELD OF THE INVENTION

This invention relates to a method of making curved windshields, side windows and rear windows for vehicles such as automobiles and the like, as well as architectural glass with an applied opaque layer.

### DISCUSSION OF THE PRIOR ART

It is known that to produce curved glass, such as a single glass sheet for use as a vehicle window, or a pair of glass sheets which are to be laminated together to produce a vehicle windshield, and other similar applications, the glass sheets must be heated to the softening point in passing through a heating furnace.

It is common practice to shape a glass sheet on a bending mold (see, for example, U.S. Pat. Nos. ## 4,983,200; 4,119,428; 4,119,424, and others) having contoured shaping rails that support an initially flat glass sheet and convey it through a heating zone. As the temperature of the supported glass approaches its heat softening temperature, it begins to sag under the force of gravity and conform to the contours of the shaping rails on the mold. Another way of achieving the required shape is to use a combination of overall and localized heating (see, for example, U.S. Pat. Nos. ## 3,880,636; 4,043,785, and others) mainly for sharp bending. As a heat source in both approaches, infrared and hot air or gas are used.

Both described processes have many disadvantages. The main ones are low quality of the shaped glass and difficulties in achieving complex shapes. It is very difficult to design a mold that will provide complex shapes. Besides, entire glass sheets need to be heated to higher temperatures, that are appropriate only for the sharp-bend areas. This creates quality problems as well as the contact of hot glass to the rolls or other mold parts. Another issue is that each and every shape requires a different mold, thereby increasing production costs. Using localized heating does not help much because neither infrared nor hot gas enable the creation of actual local heating, with sharp borders. There is still the need to heat the entire glass to high temperature.

Very often, the glass that needs to be shaped has opaque layers on its surface. Such opaque layers are used, for example, to form non-transparent borders around the peripheral marginal surfaces of glazings used as windshields and similar products. In the case of shaping a pair of glass sheets when said layers are applied to the second or third glass surfaces, separate heat processing of glass is needed to prefire these layers onto the glass surface. This cannot be accomplished during the shaping process because said layers will stick to adjoining (close-fitting) glass surfaces. This additional heating step also reduces the glass quality and increases production costs.

Extremely large numbers of windshields, windows and other products that need to be shaped or bent are made each year. Most of them have complex shapes and this percentage rises each year. Accordingly, there is a clear need in the art for a more effective and less expensive method for manufacturing curved glass.

It would also be advantageous to be able to form an opaque layer (e.g., enamel or water based) during the shaping/bending heating process, thus increasing product quality and reducing operating costs.

### SUMMARY OF THE INVENTION

According to the present invention there is provided a method of shaping glass sheets, preferably doubled sheets, to a complex shape in which the glass is passed through a furnace having a number of gas or infrared and microwave beam heating sections and at least one microwave heating section which provides final heating distribution over the glass whereby a necessary shaping profile is obtained.

The invention also comprehends curved glass, and in particular a pair of curved glass sheets which are to be laminated together to produce a vehicle windscreen, produced by the method of the invention.

Another object of this invention is to provide a method of shaping glass sheets, preferably doubled sheets with an applied opaque layer (e.g., enamel, water based, etc), whereby the layer may be exclusively fired during shaping process.

Another object of this invention is to fulfill one or more of the above-listed objects.

These products, prepared using this invention include, but are not limited to, windshields, side windows and rear windows for vehicles such as automobiles and the like as well as architectural glass.

The inventive method allows achieving complex shapes without heating glass sheets to high temperature, preserving glass optical properties, saving processing time and energy and avoids the use of a press or inefficient and unprecise local heaters such as hot air, infrared, and other.

The inventive method also allows processing (firing or curing) of the opaque layer which can be applied to any surface of the doubled glass sheet including second and third surfaces during the shaping process without marks on close-fitting glass surfaces, and saves time and energy because it avoids the need to use special furnaces for preliminary processing of the opaque layer.

The main advantages of this high-speed method are reducing manufacturing costs and increasing production rate. Many other specific advantages also exist, including, but not limited to, are the elimination of the costs and issues of transporting and transferring hot glass, compacting the size of the apparatus, increasing quality of the final product, and reducing the number of shaping/bending tools.

### BRIEF DESCRIPTION OF THE DRAWINGS

FIG. 1 is a schematic layout of a tunnel furnace according to the present invention through which glass is to be transported.

FIG. 2 schematically and graphically illustrates the temperature profiles that are obtained in the doubled glass with the opaque layer on a third surface when it is irradiated by a microwave beam.

FIGS. 3a and 3b schematically illustrate the possible ways of irradiating the area where an opaque layer is applied by the microwave beam.

FIGS. 4a and 4b schematically illustrate the possible ways of irradiating the glass to achieve the necessary shaping profile.

### DETAILED DESCRIPTION OF THE INVENTION

The present invention relates to a method of shaping a glass sheet, preferably doubled sheets, to a complex shape and firing or curing of the opaque layer applied on the glass during the shaping process that is conducted in a tunnel furnace 1 (see FIG. 1) that is divided into a number of gas or infrared and microwave beam heating sections. The glass sheet temperature rises from room temperature at the beginning of the furnace to shaping/bending temperature at the end.

The firing or curing of the peripheral opaque layer is conducted in the microwave beam heating section 3, that is located after initial heating section 2 which provides heating of the glass to a temperature lower than the firing or curing temperature of the opaque layer.

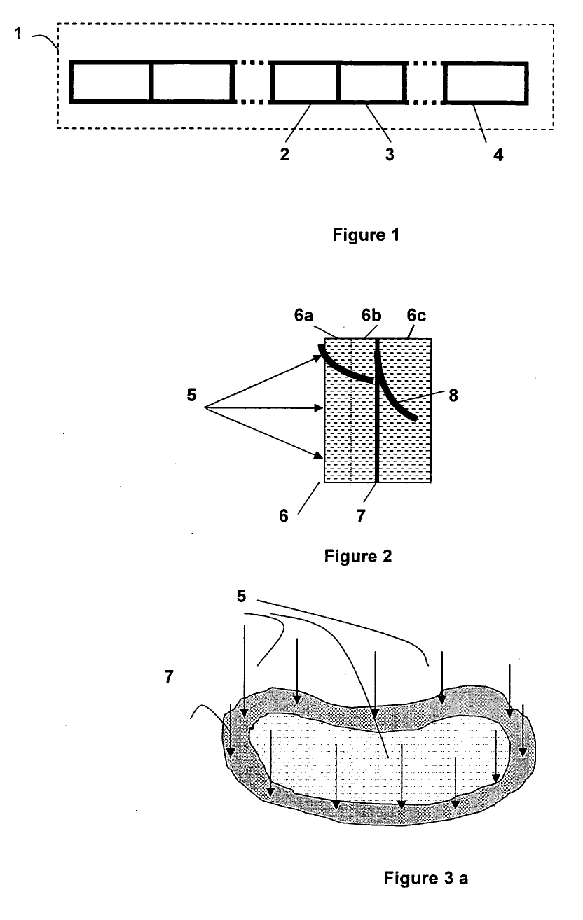

When microwave beam 5 is applied to glass sheets 6 (see FIG. 2) with applied opaque layer 7, the microwave beam passes through the glass sheets 6 and layer 7 and heats them. The glass layers that are closest to the microwave radiation source (e.g., external surface layer 6a) absorbs part of the microwave radiation 5 and, consequently, the next layer (e.g., 6b) is heated less. The level to which the opaque layer 7 is heated is dependent on the layer absorption properties. Because they are always higher than these properties in glass, its temperature is higher than the temperature of the layer 6b and especially of close-fitting layer 6c of the second glass (see temperature profile curve 8) because it shields the layer 6c from the microwave beam. As a result, the necessary processing temperature of the opaque layer 7 can be achieved while the temperature of the layer 6c remains significantly lower. This allows the curing or firing of the opaque layer during the shaping process and avoids sticking together of the glass sheets or even creation of any marks on the close-fitting glass surface.

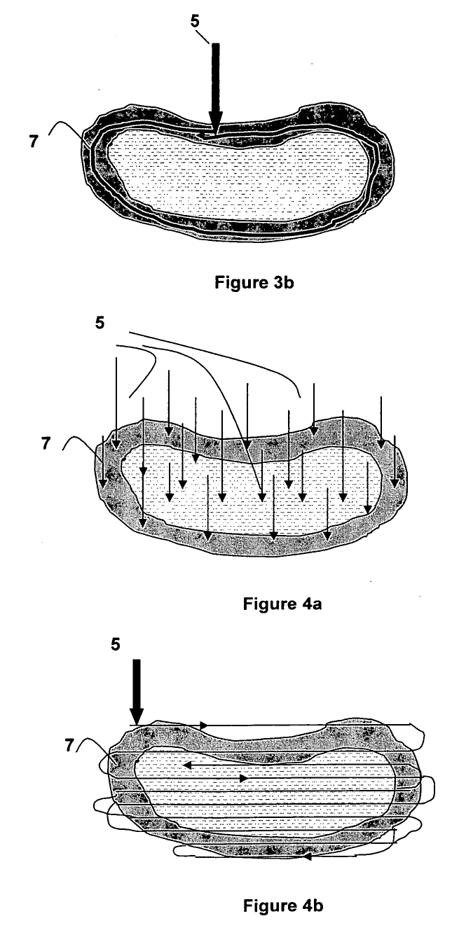

To heat the opaque layer 7 (see FIG. 3a) exclusively, the microwave beam power density 5 is configured correspondent to the shape of the opaque layer and heats it all at once. Another way of curing or firing the opaque layer 7 is scanning the microwave beam 5 over the glass area where the layer 7 is applied as is shown in FIG. 3b.

Energy efficiency and speed of processing of the opaque layer can be significantly increased by adding into the material of the opaque layer microwave absorber powders such as metal, carbon and carbon ceramics, graphite, and some semiconductor type oxide ceramics. The optimal size of powder particles should be around the skin layer size for the microwave beam that is used for processing the opaque layer.

In the inventive method the microwave beam frequency is between about 10 GHz to about 200 GHz and appropriate power density is used. The process parameters are chosen so as to accomplish curing or firing of the opaque layer in a selected short time while ensuring that the temperature of a close-fitting second glass surface that arises from microwave beam exposure is low enough to prevent sticking together of glass sheets or creation of any marks on the close-fitting glass surface.

In the inventive method at least one microwave beam heating section 4 (see FIG. 1) is located at the end of the tunnel furnace 1 and provides the final shaping profile by heating different glass zones to different temperatures.

Said heating can be provided by creating the necessary power density distribution inside the microwave beam 5 (see FIG. 4a) and irradiating the entire glass 7 at once. Another way is scanning the microwave beam 5 (see FIG. 4b) that is focused to the necessary shape and size over glass 7. There are different forms of scanning passes that can be used: horizontal, vertical, spiral, etc. In the inventive method the microwave beam frequency is between about 10 GHz to about 200 GHz and appropriate power density is used. The process parameters: frequency, power density, and scanning speed between and inside the zones are chosen so as to accomplish heating different zones to controllable different temperatures in a selected short time whereby a necessary shaping profile is obtained.

The present invention has been described in an illustrative manner. It is to be understood that the terminology that has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A method of shaping a glass sheet, preferably doubled sheets, to a complex shape with an opaque layer applied on at least one glass sheet surface, the method comprising: passing the glass sheet through a furnace having at least one initial heating section, and at least one microwave beam heating section for providing firing or curing of the opaque layer and shaping of the sheet, and thereby initially heating the glass sheet to a predetermined temperature in the initial heating section, then firing or curing the opaque layer with a microwave beam to a higher temperature sufficient for firing or curing, and finally heating the glass sheet over a desired area of distribution with a microwave beam for obtaining a necessary shaping profile.

2. The method of claim 1 wherein the microwave beam of the heating section that provides firing or curing is configured correspondent to the shape of the opaque layer and firing or curing of the opaque layer is accomplished all at once.

3. The method of claim 1 wherein the microwave beam of the heating section that provides firing or curing scans the opaque layer whereby firing or curing the opaque layer is accomplished by scanning the microwave beam over the opaque layer.

4. The method of claim 1 wherein final heating with the microwave beam of the heating section that provides final heating is accomplished by heating the glass sheet all at once and its power density distribution is configured correspondent to the necessary shaping profile.

5. The method of claim 1 wherein final heating with the microwave beam of the heating section that provides final heating is accomplished by scanning the glass with the microwave beam in a scanning velocity distribution correspondent to the necessary shaping profile.

6. The method of claim 1 wherein the microwave beam frequency is selected to be between about 10 GHz to about 200 GHz.

7. The method of claim 1 wherein said initial heating includes heating with gas or infrared radiation.
